(19) United States
(12) Patent Application Publication
(10) Pub. No.: US 2007/0157053 A1
(43) Pub. Date: Jul. 5, 2007

(54) POWER-SWITCHING CIRCUIT WITH OVERLOAD PROTECTION FROM A SERIAL BUS INTERFACE AND METHOD OF DRIVING THE SAME

(76) Inventors: Kuang-Yao Lee, Taipei Hsien (TW); Chin-Li Huang, Taipei Hsien (TW); I-Ming Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/308,158

(22) Filed: Mar. 9, 2006

(30) Foreign Application Priority Data
Jan. 3, 2006 (TW) 095100233

(51) Int. Cl. G06F 11/00

(52) U.S. Cl. 714/22

(57) ABSTRACT

A power-switching circuit includes an interface, a voltage regulator, a voltage detector and a power switch. The interface is for coupling a peripheral device. The voltage regulator provides constant-power output at an output end. An input end of the voltage detector is coupled to the output end of the voltage regulator for generating trigger signals based on voltages established at the output end of the voltage regulator. An input end of the power switch is coupled to the output end of the voltage regulator. A trigger end of the power switch is coupled to the output end of the voltage detector for receiving trigger signals generated by the voltage detector. An output end of the power switch is coupled to the interface for providing output voltages to the interface based on signals received at the input and trigger ends of the power switch.

### BACKGROUND OF THE INVENTION

1. Field of the Invention

The present invention relates to a power-switching circuit, and more particularly, to a power-switching circuit with overload protection from a serial bus interface.

2. Description of the Prior Art

Though wireless networks become more and more common and provide excellent efficiency, some tasks, such as power transmission, still require wired networks. A device, either receiving network signals via a wireless network or via a wired network, needs power for normal operation. Using a power-over-Ethernet (POE) system, installers only need to run a single Ethernet cable that carries both power and data to each device. This allows greater flexibility in the locating of access points (APs) and network devices and significantly decreases installation costs in many cases. Though the concepts of supplying power using a POE system have existed for a long time, more efforts have been put into the development of related products after the IEEE (Institute of Electrical and Electronics Engineers) completed the 802.3af specification in June 2003. Based on the IEEE 802.3af specification, the maximum power supply of POE switches is 12.96W (watt). The power supply output is categorized in three levels: 0.44-3.84W, 3.84-6.49W, and 6.49-12.95W, together with an extra power supply output level of 0.44-12.95W for POE switches unable to monitor power consumption.

Internet Voice, also known as Voice over Internet Protocol (VoIP), is a technology that allows you to make telephone calls using a broadband Internet connection instead of a regular phone line. A VoIP device usually includes a Universal Serial Bus (USB) interface for coupling peripheral devices to the VoIP device. The maximum output current provided by a USB interface varies with different types of VoIP devices, peripheral devices, or USB hubs. The typical maximum output current of a USB interface is usually 100 mA or 500 mA. DC adaptors or POE switches are normally used for supplying power to the VoIP devices. Since the maximum power supply of POE switches is 12.96W according to the IEEE 802.3af specification, it is preferable to lower the maximum output current of the USB interface to a value smaller than 100 mA, so that peripheral devices will not draw too much current via the USB interface and affect the normal operations of the VoIP device.

FIG. 1 is a diagram of a prior art power-switching circuit 10 for a VoIP device. The power-switching circuit 10 includes a power supply 12, a POE switch 14, and a USB interface 16. The power switch 14, which can include USB power switches commonly available in the market, can be regarded as a system control interface that controls the power supply of the power-switching circuit 10. When the VoIP device is working normally, the power switch 14 receives a working voltage provided by the power supply 12 at its input end PIN, and outputs the working voltage to the USB interface 16 at its output end POUT after a predetermined period of time. When over-current or over-heat is detected, the power switch 14 cuts off current path between the power supply 12 and the USB interface 16 to avoid damaging the power-switching circuit 10 or the peripheral devices due to abnormal operations. The minimum current limit of the USB power switches currently available is around 150 mA, which does not meet the 100 mA minimum current limit required by the USB interface. When the peripheral devices coupled to the power-switching circuit 10 are somehow short-circuited, or when the USB interfaces 16 are overloaded with too many peripheral devices, the USB interfaces 16 will draw a large amount of current from the power supply 12, thereby influencing the operations of the power-switching circuit 10.

### SUMMARY OF THE INVENTION

The claimed invention provides a power-switching circuit with overload protection from a serial bus interface comprising an interface for coupling a peripheral device; a voltage regulator for providing constant-power output at an output end; a voltage detector having an input end coupled to the output end of the voltage regulator for generating trigger signals based on voltages established at the output end of the voltage regulator; and a power switch comprising an input end coupled to the output end of the voltage regulator; a trigger end coupled to the output end of the voltage detector for receiving trigger signals; and an output end coupled to the interface for sending an output voltage to the interface based on voltages established at the input end of the power switch and the trigger signals.

The claimed invention also provides a driving method providing overload protection from a serial bus interface comprising providing constant-power output at an output end of a voltage regulator; generating trigger signals using a voltage detector based on voltages established at the output end of the voltage regulator; and receiving the output provided by the voltage regulator and the trigger signals using a power switch and generating a corresponding output voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art power-switching circuit for a VoIP device.

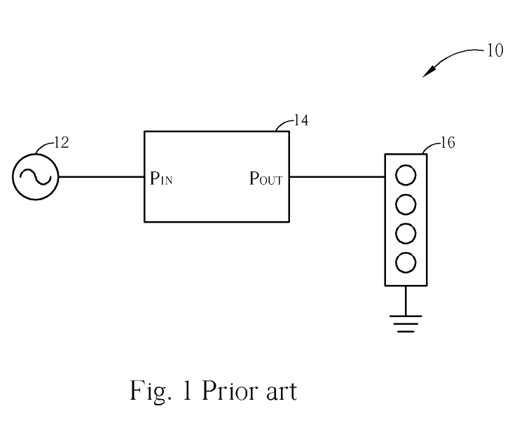

FIG. 2 is a diagram of a power-switching circuit for a VoIP device according to the present invention.

FIG. 3 shows a signal diagram of the power-switching circuit in FIG. 2 under normal operations.

FIG. 4 shows a signal diagram of the power-switching circuit in FIG. 2 when working with overload current.

FIG. 5 shows another signal diagram of the power-switching circuit in FIG. 2 when working with overload current.

FIG. 6 shows a diagram of a voltage detector of the power-switching circuit in FIG. 2.

FIG. 7 shows a flowchart illustrating the operations of the power-switching circuit in FIG. 2 according to the present invention.

### DETAILED DESCRIPTION

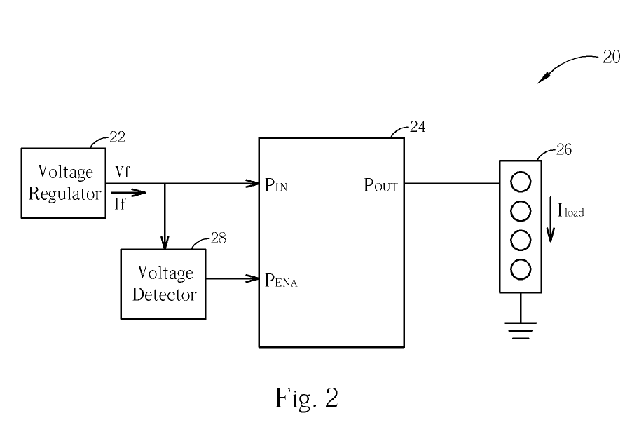

FIG. 2 is a diagram of a power-switching circuit 20 for a VoIP device according to the present invention. The power-switching circuit 20 includes a voltage regulator 22, a power switch 24, a USB interface 26, and a voltage detector 28. Peripheral devices can be coupled to the power-switching circuit 20 via the USB interface 26. The voltage regulator 22 provides a constant-power output at an output end. The power switch 24 includes an input end P_{IN} coupled to the output end of the voltage regulator 22, an output end P_{OUT} coupled to the USB interface 26, and the trigger end P_{ENA} coupled to an output end of the voltage detector 28. The voltage detector 28, having an input end coupled to the output end of the voltage regulator 22, generates trigger signals to the trigger end P_{ENA} of the power switch 24 based on the voltage established at the output end of the voltage regulator 22.

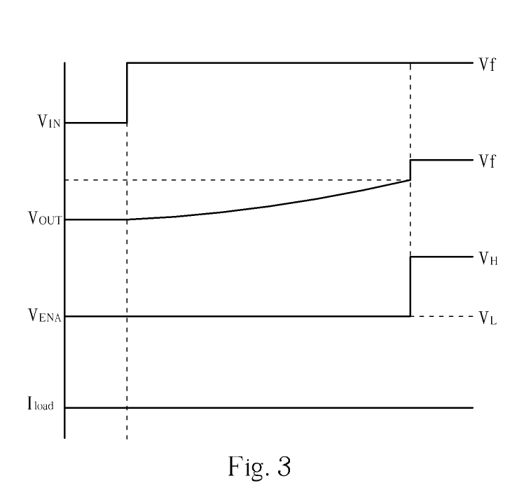

Operations of the power-switching circuit 20 will be described. In the present invention, a reference voltage V_{ref} is provided for the power-switching circuit 20, and the power switch 24 is turned on or turned off based on the voltage established at the output end of the voltage regulator 22 and the reference voltage V_{ref}. The voltage regulator 22 provides a working voltage Vf and a working current, and at its output end, the working voltage Vf is sent to the input end P_{IN} of the power switch 24 and the output end of the voltage detector 28 at the same time. During normal operations, a load current I_{load} of the USB interface 26 does not exceed its minimum current limit, and the voltage established at the input end of the voltage detector 28 is larger than the reference voltage V_{ref}. At this time, the voltage detector 28 generates a trigger signal having a high voltage level V_{H} at its output end and sends the trigger signal to the trigger end P_{ENA} of the power switch 24. Therefore, the power switch 24 can be turned on and provide the working voltage Vf to the USB interface 26 at the output end P_{OUT}. FIG. 3 shows a signal diagram of the power-switching circuit 20 under normal operations. In FIG. 3, voltages established at the input end P_{IN}, the output end P_{OUT}, and the trigger end P_{ENA} of the power switch 24 are represented by V_{IN}, V_{OUT}, and V_{ENA}, respectively, and the load current of the USB 26 is represented by I_{load}. As shown in FIG. 3, when the trigger end P_{ENA} of the power switch 24 receives a trigger signal having a high voltage level V_{H}, the power switch 24 is turned on and the voltage level of the output end P_{OUT} reaches Vf.

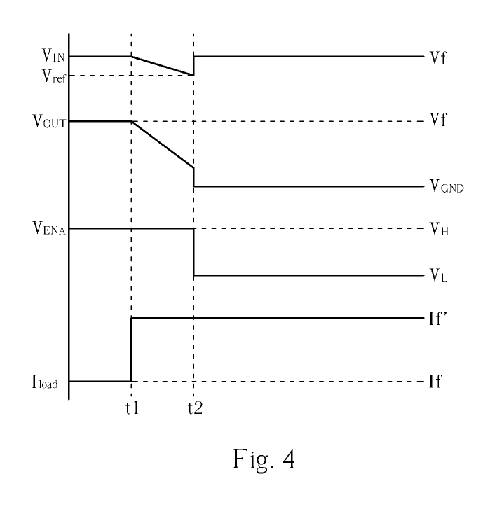

If the peripheral devices coupled to the power-switching circuit 20 via the USB interface 26 are somehow short-circuited, or the USB interfaces 26 are overloaded with too many peripheral devices, the load current I_{load} of the USB interfaces 26 increases accordingly. Since the voltage regulator 22 provides a constant-power output, the working voltage Vf decreases with increasing load current I_{load}, and the voltages V_{IN} and V_{OUT} of the input end P_{IN} and output end P_{OUT} of the power switch 24 also drop accordingly. Once the voltage V_{IN} becomes smaller than the reference voltage V_{ref}, the voltage detector 28 generates a trigger signal having a low voltage level V_{L} at its output end and sends the trigger signal to the trigger end P_{ENA} of the power switch 24, thereby turning off the power switch 24. After the power switch 24 is turned off, the voltage V_{IN} of the input end P_{IN} rises to Vf again. FIG. 4 shows a signal diagram of the power-switching circuit 20 when working with overload current. FIG. 3 shows a signal diagram when the power-switching circuit 20 is working normally. In FIG. 4, voltages established at the input end P_{IN}, the output end P_{OUT}, and the trigger end P_{ENA} of the power switch 24 are represented by V_{IN}, V_{OUT}, and V_{ENA}, respectively, and the load current of the USB 26 is represented by I_{load}. As shown in FIG. 4, when the load current I_{load} increases from If to If′ at t1, the voltages V_{IN} and V_{OUT} are pulled down. At t2 when the voltage V_{IN} becomes smaller than the reference voltage V_{ref}, the voltage detector 28 generates a trigger signal having a low voltage level V_{L} at its output end and sends the trigger signal to the trigger P_{ENA} end of the power switch 24, thereby turning off the power switch 24. After the power switch 24 is turned off, the voltage V_{IN} of the input end P_{IN} rises to Vf again, and the voltage V_{OUT} of the output end P_{OUT} drops to a low level V_{GND}.

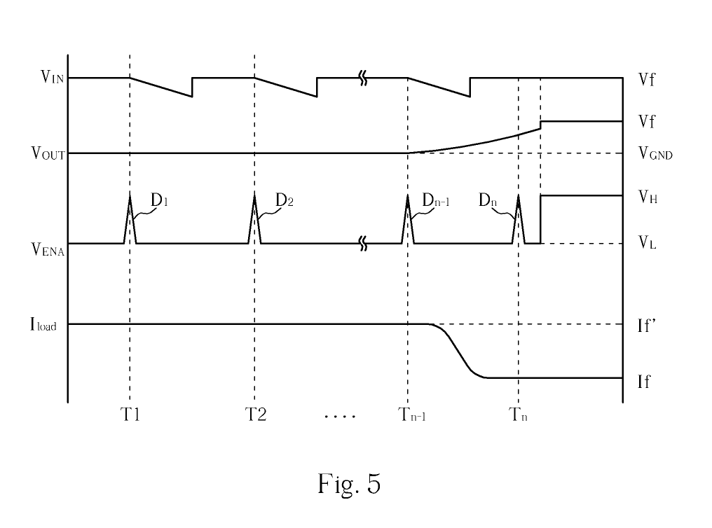

FIG. 5 shows another signal diagram of the power-switching circuit 20 when working with overload current. When the power switch 24 is turned off when the load current I_{load} is too large, a plurality of pulses D₁-Dₙ each having a high voltage level V_{H} are generated at the trigger end P_{ENA} at T₁-Tₙ, thereby turning on the power switch 24 exactly at T₁-Tₙ. If whatever causing the over-large load current I_{load} still exists, the load current I_{load} is kept at a value If′ larger than its minimum current limit. The voltage V_{IN} established at the input end P_{IN} of the power switch 24 will still be pulled down at the exact moment when the power switch 24 is turned on by the pulses D₁-Dₙ. The trigger end P_{ENA} of the power switch 24 is kept at a low voltage level V_{L} after sending each pulse of the pulses D₁-Dₙ. The power switch 24 remains off except at the exact moments when the pulses D₁-Dₙ are applied at T₁-Tₙ. The voltage V_{IN} established at the input end P_{IN} of the power switch 24 still remains at a low voltage level V_{GND}.

If whatever causing the over-large load current I_{load} is excluded between Tₙ₋₁ and Tₙ., the load current I_{load} will become smaller than its minimum current limit If. Therefore, when the power switch 24 is turned on by the pulse Dₙ at Tₙ, the voltage V_{IN} established at the input end P_{IN} will not be pulled down. The voltage generator 28 then generates a trigger signal having a high voltage level V_{H} at its output end and sends the trigger signal to the trigger end P_{ENA} of the power switch 24, thereby turning on the power switch 24. At this time, the voltage V_{OUT} established at the input end P_{OUT} of the power switch 24 rises to Vf, and the peripheral devices coupled to the power-switching circuit 20 can begin to operate again.

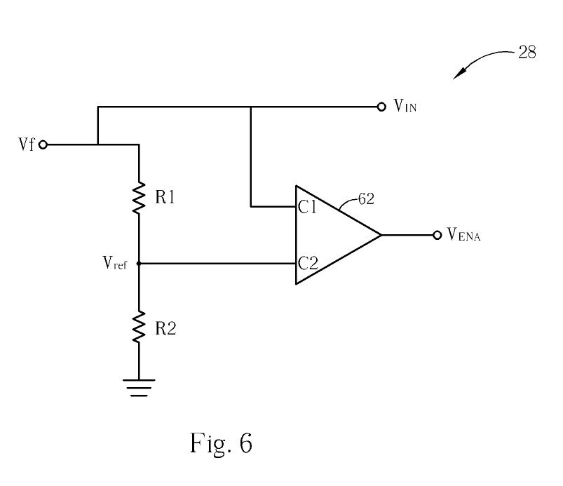

FIG. 6 shows a diagram of the voltage detector 28 of the power-switching circuit 20. The voltage detector 28 includes a comparator 62 and resistors R1 and R2. The comparator 62 includes a first input end C1 coupled to the output end of the voltage regulator 22, and a second input end C2 coupled between the resistors R1 and R2. The voltages established the first input end C1 and the second input end C2 of the comparator 62 are represented by Vf and V_{ref}, respectively. Different reference voltages V_{ref} can be provided for the power-switching circuit 20 by changing the resistance of the resistors R1 and R2. The comparator 62 generates trigger signals based on the voltages Vf and V_{ref}. When the voltage Vf is larger than the reference voltage V_{ref}, the power-switching circuit 20 is working normally, and the load current I_{load} does not exceed its minimum current limit. At this time, the comparator 62 generates a trigger signal having a high voltage level at its output end. When the voltage Vf is smaller than the reference voltage V_{ref}, the load current I_{load} exceeds its minimum current limit, and the comparator 62 generates a trigger signal having a low voltage level at its output end. The voltage detector 28 shown in FIG. 6 merely illustrates an embodiment of the present invention. Other types of comparing circuits can also be adopted for the voltage detector 28.

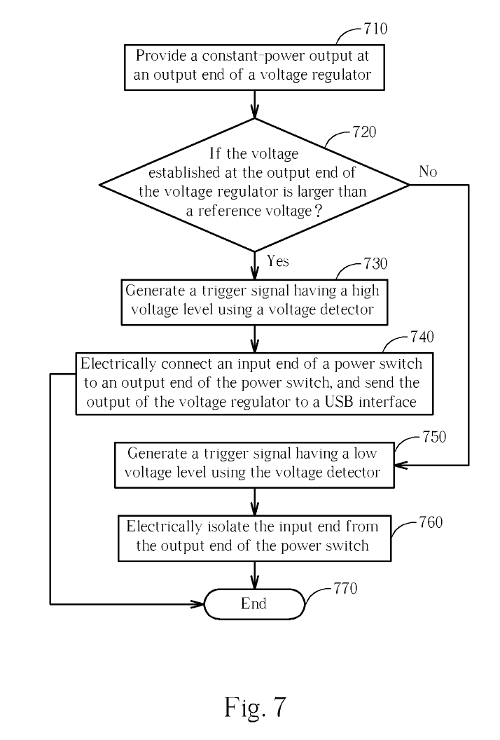

FIG. 7 shows a flowchart illustrating the operations of the power-switching circuit 20 according to the present invention. The flowchart in FIG. 7 includes the following steps:

Step 710: Provide a constant-power output at the output end of the voltage regulator 22;

Step 720: Determine whether the voltage established at the output end of the voltage regulator 22 is larger than a reference voltage V_{ref} using the voltage detector 28; if the voltage established at the output end of the voltage regulator 22 is larger than a reference voltage V_{ref}, execute step 730; if the voltage established at the output end of the voltage regulator 22 is not larger than a reference voltage V_{ref}, execute step 750;

Step 730: Generate a trigger signal having a high voltage level using the voltage detector 28;

Step 740: Electrically connect the input end P_{IN} of the power switch 24 to the output end P_{OUT} of the power switch 24, and send the output of the voltage regulator 22 to the USB interface 26; execute step 770;

Step 750: Generate a trigger signal having a low voltage level using the voltage detector 28;

Step 760: Electrically isolate the input end P_{IN} from the output end P_{OUT} of the power switch 24; and

Step 770: End.

The power-switching circuits of the present invention can be applied to VoIP devices, as well as portable multi-media players (PMPs) or other devices. In the power-switching circuit of the present invention, the interface can include a USB interface or an IEEE 1394 interface, and the power switch can include USB power switches widely available in the market, such as MIC2012 of MICREL.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power-switching circuit with overload protection from a serial bus interface comprising:
an interface for coupling a peripheral device;
a voltage regulator for providing constant-power output at an output end;
a voltage detector having an input end coupled to the output end of the voltage regulator for generating trigger signals based on voltages established at the output end of the voltage regulator; and
a power switch comprising:
an input end coupled to the output end of the voltage regulator;
a trigger end coupled to the output end of the voltage detector for receiving trigger signals; and
an output end coupled to the interface for sending an output voltage to the interface based on voltages established at the input end of the power switch and the trigger signals.

2. The power-switching circuit of claim 1 wherein the voltage detector comprises:
a resistor string comprising a plurality of resistors coupled in series, the resistor string having an end coupled to the output end of the voltage regulator; and
a comparator having a first input end coupled to the output end of the voltage regulator and a second input end coupled between two resistors of the resistor string for generating trigger signals according to voltages established at the first and second input ends of the comparator.

3. The power-switching circuit of claim 1 wherein the interface includes a universal serial bus (USB) interface.

4. The power-switching circuit of claim 1 wherein the interface includes an IEEE 1394 interface.

5. The power-switching circuit of claim 1 being a power-switching circuit of a portable multi-media player (PMP).

6. The power-switching circuit of claim 1 being a power-switching circuit of a voice over internet protocol (VoIP) device.

7. A driving method providing overload protection from a serial bus interface comprising:
providing constant-power output at an output end of a voltage regulator;
generating trigger signals using a voltage detector based on voltages established at the output end of the voltage regulator; and
receiving the output provided by the voltage regulator and the trigger signals using a power switch and generating a corresponding output voltage.

8. The driving method of claim 7 further comprising:
determining whether a voltage established at the output end of the voltage regulator is larger than a reference voltage using the voltage detector.

9. The driving method of claim 8 wherein when the voltage established at the output end of the voltage regulator is larger than the reference voltage, the driving method further comprises:
generating a trigger signal having a high voltage level using the voltage detector.

10. The driving method of claim 8 wherein when the voltage established at the output end of the voltage regulator is not larger than the reference voltage, the driving method further comprises:
generating a trigger signal having a low voltage level using the voltage detector.

11. The driving method of claim 8 wherein when the voltage established at the output end of the voltage regulator is larger than the reference voltage, the driving method further comprises:
generating an output voltage having a same voltage level as the voltage established at the output end of the voltage regulator using the power switch.

12. The driving method of claim 8 wherein when the voltage established at the output end of the voltage regulator is not larger than the reference voltage, the driving method further comprises:
generating an output voltage having ground level.

13. The driving method of claim 7 wherein generating a corresponding output voltage comprises providing a corresponding output voltage to an interface using the power switch.
